(19) United States
(12) Patent Application Publication
(10) Pub. No.: US 2014/0278372 A1
(43) Pub. Date: Sep. 18, 2014

(54) AMBIENT SOUND RETRIEVING DEVICE AND AMBIENT SOUND RETRIEVING METHOD

(71) Applicant: HONDA MOTOR CO., LTD., Tokyo (JP)

(72) Inventors: Kazuhiro NAKADAI, Wako-shi (JP); Keisuke NAKAMURA, Wako-shi (JP); Yusuke YAMAMURA, Wako-shi (JP); Hiroshi OKUNO, Wako-shi (JP)

(73) Assignee: HONDA MOTOR CO., LTD., Tokyo (JP)

(21) Appl. No.: 14/196,079

(22) Filed: Mar. 4, 2014

(30) Foreign Application Priority Data
Mar. 14, 2013 (JP) 2013-052424

(51) Int. Cl. G06F 17/30

(52) U.S. Cl. CPC G06F 17/30752
USPC 704/9; 704/205

(57) ABSTRACT

An ambient sound retrieving device includes a sound input unit receiving a sound signal, a sound recognition unit performing a speech recognition process on the sound signal and generating an onomatopoeic word, a sound data storage unit storing an ambient sound and an onomatopoeic word corresponding to the ambient sound, a correlation information storage unit storing correlation information in which a first onomatopoeic word, a second onomatopoeic word, and a frequency of selecting the second onomatopoeic word are correlated with each other, a conversion unit converting the first onomatopoeic word into the second onomatopoeic word corresponding to the first onomatopoeic word using the correlation information, and a retrieval and extraction unit extracting the ambient sound corresponding to the second onomatopoeic word from the sound data storage unit and ranking and presenting a plurality of candidates of the extracted ambient sound.

### CROSS REFERENCE TO RELATED APPLICATIONS

Priority is claimed on Japanese Patent Application No. 2013-052424, filed on Mar. 14, 2013, the contents of which are entirely incorporated herein by reference.

### BACKGROUND OF THE INVENTION

1. Field of the Invention

The present invention relates to an ambient sound retrieving device and an ambient sound retrieving method.

2. Description of Related Art

When a user retrieves a desired sound from sound sources, it actually takes time for the user to retrieve the desired sound from sound sources. Accordingly, a device that retrieves a sound desired by a user out of a lot of sound data pieces has been proposed.

For example, in the technique described in Japanese Patent No. 2897701 (Patent Document 1), an acoustic feature amount of a character string input from an onomatopoeic word input device is converted, and waveform data satisfying the converted acoustic feature amount is retrieved from a sound effect database in which a plurality of sound effect data pieces are accumulated. Here, the onomatopoeic word is a word abstractly expressing a certain sound. The acoustic feature amount of a character string is a numerical value indicating a length or a frequency characteristic of a sound (waveform data).

In the technique described in “Sound Sources Selection System by Using Onomatopoeic Queries from Multiple Sound Sources”, Yusuke Yamamura, Toni Takahashi, Tetsuya Ogata, and Hiroshi G. Okuno, 2012 IEEE/RSJ International Conference on Intelligent Robots and Systems, IEEE, 2012.10 (Non-patent Document 1), a speech recognition process is performed on a plurality of sound source signals. In the technique described in Non-patent Document 1, there is a proposal that a user estimates a desired sound source by comparing the similarity of an onomatopoeic word emitted by the user to the recognized sound source signals.

However, in the techniques described in Patent Document 1 and Non-patent Document 1, when a user inputs an onomatopoeic word for retrieval, a plurality of sound effect data pieces may be retrieved as candidates, but a method of determining a sound effect data piece desired by the user out of the plurality of candidates is not disclosed. Accordingly, in the technique described in Patent Document 1, there is a problem in which it is difficult to obtain the sound effect data piece desired by the user when there are a plurality of sound effect data pieces corresponding to the input onomatopoeic word to be retrieved.

### SUMMARY OF THE INVENTION

The invention is made in consideration of the above-mentioned problem and an object thereof is to provide an ambient sound retrieving device and an ambient sound retrieving method which can efficiently provide a sound effect data piece desired by a user even when a plurality of candidates are present.

(1) According to an aspect of the invention, there is provided an ambient sound retrieving device including: a sound input unit configured to receive a sound signal; a sound recognition unit configured to perform a speech recognition process on the sound signal input to the sound input unit and to generate an onomatopoeic word; a sound data storage unit configured to store an ambient sound and an onomatopoeic word corresponding to the ambient sound; a correlation information storage unit configured to store correlation information in which a first onomatopoeic word, a second onomatopoeic word, and a frequency of selecting the second onomatopoeic word when the first onomatopoeic word is recognized by the sound recognition unit are correlated with each other; a conversion unit configured to convert the first onomatopoeic word recognized by the sound recognition unit into the second onomatopoeic word corresponding to the first onomatopoeic word using the correlation information stored in the correlation information storage unit; and a retrieval and extraction unit configured to extract the ambient sound corresponding to the second onomatopoeic word converted by the conversion unit from the sound data storage unit and to rank and present a plurality of candidates of the extracted ambient sound based on frequencies of selecting the plurality of candidates of the extracted ambient sound.

(2) In the ambient sound retrieving device according to another aspect of the invention, the first onomatopoeic word may be obtained by causing the sound recognition unit to recognize an onomatopoeic word corresponding to the ambient sound, and the second onomatopoeic word may be obtained by causing the sound recognition unit to recognize the ambient sound.

(3) In the ambient sound retrieving device according to another aspect of the invention, the first onomatopoeic word in the correlation information may be determined so that a recognition rate at which the second onomatopoeic word is recognized as the onomatopoeic word corresponding to the candidate of the ambient sound is equal to or greater than a predetermined value.

(4) According to still another aspect of the invention, there is provided an ambient sound retrieving device including: a text input unit configured to receive text information; a text recognition unit configured to perform a text extraction process on the text information input to the text input unit and to generate an onomatopoeic word; a sound data storage unit configured to store an ambient sound and an onomatopoeic word corresponding to the ambient sound; a correlation information storage unit configured to store correlation information in which a first onomatopoeic word, a second onomatopoeic word, and a frequency of selecting the second onomatopoeic word when the first onomatopoeic word is extracted by the text recognition unit are correlated with each other; a conversion unit configured to convert the first onomatopoeic word extracted by the text recognition unit into the second onomatopoeic word corresponding to the first onomatopoeic word using the correlation information stored in the correlation information storage unit; and a retrieval and extraction unit configured to extract the ambient sound corresponding to the second onomatopoeic word converted by the conversion unit from the sound data storage unit and to rank and present a plurality of candidates of the extracted ambient sound based on frequencies of selecting the plurality of candidates of the extracted ambient sound.

(5) According to still another aspect of the invention, there is provided an ambient sound retrieving method including: a sound data storing step of storing an ambient sound and an onomatopoeic word corresponding to the ambient sound as sound data; a sound input step of inputting a sound signal; a sound recognizing step of performing a speech recognition process on the sound signal input in the sound input step and generating an onomatopoeic word; a correlation information storing step of storing correlation information in which a first onomatopoeic word, a second onomatopoeic word, and a frequency of selecting the second onomatopoeic word when the first onomatopoeic word is recognized in the sound recognizing step are correlated with each other; a conversion step of converting the first onomatopoeic word recognized in the sound recognizing step into the second onomatopoeic word corresponding to the first onomatopoeic word using the correlation information; an extraction step of extracting the ambient sound corresponding to the second onomatopoeic word converted in the conversion step from the sound data storage unit; a ranking step of ranking a plurality of candidates of the extracted ambient sound based on frequencies of selecting the plurality of candidates of the extracted ambient sound; and a presentation step of presenting the plurality of candidates of the ambient sound ranked in the ranking step.

(6) According to still another aspect of the invention, there is provided an ambient sound retrieving method including: a sound data storing step of storing an ambient sound and an onomatopoeic word corresponding to the ambient sound as sound data; a text input step of inputting text information; a text recognizing step of performing a text extraction process on the text information input in the text input step and generating an onomatopoeic word; a correlation information storing step of storing correlation information in which a first onomatopoeic word, a second onomatopoeic word, and a frequency of selecting the second onomatopoeic word when the first onomatopoeic word is recognized in the text recognizing step are correlated with each other; a conversion step of converting the first onomatopoeic word recognized in the text recognizing step into the second onomatopoeic word corresponding to the first onomatopoeic word using the correlation information; an extraction step of extracting the ambient sound corresponding to the second onomatopoeic word converted in the conversion step from the sound data; a ranking step of ranking a plurality of candidates of the extracted ambient sound based on frequencies of selecting the plurality of candidates of the ambient sound extracted in the extraction step; and a presentation step of presenting the plurality of candidates of the ambient sound ranked in the ranking step.

According to the aspects of (1), (2), and (5) of the invention, candidates of an ambient sound are extracted from the sound data storage unit using the second onomatopoeic word into which the first onomatopoeic word obtained by recognizing the input sound source is converted using the correlation information, and the extracted candidates of the ambient sound are ranked and presented. Accordingly, it is possible to efficiently provide a sound effect data piece desired by a user even when a plurality of candidates are present.

According to the aspect of (3) of the invention, the first onomatopoeic word is converted into the second onomatopoeic word using the correlation information in which the first onomatopoeic word is determined so that a recognition rate at which the second onomatopoeic word is recognized as the onomatopoeic word corresponding to the candidate of the ambient sound is equal to or greater than a predetermined value. Accordingly, it is possible to accurately extract a plurality of candidates of an ambient sound.

According to the aspects of (4) and (6) of the invention, candidates of an ambient sound are extracted from the sound data storage unit using the second onomatopoeic word into which the first onomatopoeic word obtained by recognizing the input text is converted using the correlation information, and the extracted candidates of the ambient sound are ranked and presented. Accordingly, it is possible to efficiently provide a sound effect data piece desired by a user even when a plurality of candidates are present.

### BRIEF DESCRIPTION OF THE DRAWINGS

FIG. 1 is a block diagram illustrating a configuration of an ambient sound retrieving device according to a first embodiment of the invention.

FIG. 2 is a diagram illustrating a relationship between a sound signal of an ambient sound and a tag in the first embodiment.

FIG. 3 is a diagram illustrating information stored in a system dictionary in the first embodiment.

FIG. 4 is a diagram illustrating information stored in an ambient sound database in the first embodiment.

FIG. 5 is a diagram illustrating information stored in a correlation information storage unit in the first embodiment.

FIG. 6 is a diagram illustrating an example of an ambient sound which is ranked by a ranking unit and which is presented to an output unit in the first embodiment.

FIG. 7 is a flowchart illustrating a flow of an ambient sound retrieving process which is performed by the ambient sound retrieving device according to the first embodiment.

FIG. 8 is a diagram illustrating an example of a confirmation result when candidates of an ambient sound are presented in the ambient sound retrieving device according to the first embodiment.

FIG. 9 is a block diagram illustrating a configuration of an ambient sound retrieving device according to a second embodiment of the invention.

FIG. 10 is a flowchart illustrating a flow of an ambient sound retrieving process which is performed by the ambient sound retrieving device according to the second embodiment.

### DETAILED DESCRIPTION OF THE INVENTION

First, the summary of the invention will be described below.

An ambient sound retrieving device according to the invention performs a speech recognition process on a sound emitted by a user on-line with a desired sound source as an onomatopoeic word. Then, the ambient sound retrieving device sets the recognition result as a first onomatopoeic word (user onomatopoeic word), and converts the first onomatopoeic word into a second onomatopoeic word (system onomatopoeic word) which is registered in a system dictionary prepared in advance by performing a speech recognition process on a plurality of sound sources using correlation information prepared in advance. Then, the ambient sound retrieving device retrieves a sound source corresponding to the converted second onomatopoeic word from a database in which a plurality of sound sources are registered in advance. Then, the ambient sound retrieving device ranks the retrieved sound source candidates and then presents the ranked sound source candidates to the user. Accordingly, the ambient sound retrieving device according to the invention can efficiently provide sound effect data desired by the user even when a plurality of candidates are present.

Hereinafter, embodiments of the invention will be described with reference to the accompanying drawings. An example in which a user retrieves an ambient sound using Japanese will be described below.

### First Embodiment

FIG. 1 is a block diagram illustrating a configuration of an ambient sound retrieving device 1 according to this embodiment. As illustrated in FIG. 1, the ambient sound retrieving device 1 includes a sound input unit 10, a video input unit 20, a sound signal extraction unit 30, a sound recognition unit 40, a user dictionary (acoustic model) 50, a system dictionary 60, an ambient sound database (sound data storage unit) 70, a correlation unit 80, a correlation information storage unit 90, a conversion unit 100, a sound source retrieving unit (retrieval and extraction unit) 110, a ranking unit (retrieval and extraction unit) 120, and an output unit (retrieval and extraction unit) 130.

The sound input unit 10 collects a received sound and converts the collected sound into an analog sound signal. Here, the sound collected by the sound input unit 10 is a sound based on an onomatopoeic word imitating a sound emitted from an object with words and phrases. The sound input unit 10 outputs the converted analog sound signal to the sound recognition unit 40. The sound input unit 10 is, for example, a microphone that receives sound waves in a frequency band (for example, 200 Hz to 4 kHz) of a speech emitted from a person.

The video input unit 20 outputs a video signal including a sound signal input from the outside to the sound signal extraction unit 30. The video signal input from the outside may be an analog signal or a digital signal. When an input video signal is an analog signal, the video input unit 20 may convert the input video signal into a digital signal and then may output the converted digital signal to the sound signal extraction unit 30. Only the sound signal may be retrieved. In this case, the ambient sound retrieving device 1 may not include the video input unit 20 and the sound signal extraction unit 30.

The sound signal extraction unit 30 extracts a sound signal of an ambient sound from the sound signal included in the video signal output from the video input unit 20. Here, the ambient sound is a sound other than a sound emitted from a person or music, and examples thereof include a sound emitted from a tool when a person operates the tool, a sound emitted from an object when a person beats the object, a sound emitted when a sheet of paper is torn, a sound emitted when an object collides with another object, a sound emitted by wind, a sound of waves, and a sound of crying emitted from an animal. The sound signal extraction unit 30 outputs a sound signal of the extracted ambient sound to the sound recognition unit 40. The sound signal extraction unit 30 stores the sound signal of the extracted ambient sound in the ambient sound database 70 in correlation with position information indicating a position from which the sound signal of the ambient sound is extracted.

The sound recognition unit 40 performs a speech recognition process on the sound signal output from the sound input unit 10 using a known speech recognition method and using an acoustic model and a language model for speech recognition stored in the user dictionary 50. The sound input unit 10 determines a phoneme sequence successively extending from a recognized phoneme as a phoneme sequence (u) corresponding to a sound signal of an onomatopoeic word. The sound recognition unit 40 outputs the determined phoneme sequence (u) to the conversion unit 100. The sound recognition unit 40 performs the speech recognition using a large vocabulary continuous speech recognition engine including an acoustic model for speech recognition indicating a relationship between a sound feature amount and a phoneme and a language model indicating a relationship between a phoneme and a language element such as a word.

The sound recognition unit 40 performs a recognition process on the sound signal of the ambient sound output from the sound signal extraction unit 30 using a known recognition method and using the acoustic model for the sound signal of the ambient sound stored in the system dictionary 60. For example, the sound recognition unit 40 calculates a sound feature amount of the sound signal of the ambient sound. The sound feature amount is, for example, a thirty-fourth-order mel-frequency cepstrum coefficient (MFCC). The sound recognition unit 40 performs a speech recognition process on the sound signal using a known phonemic recognition method and using the system dictionary 60 based on the calculated sound feature amount. The recognition result of the sound recognition unit 40 is a phonemic notation.

The sound recognition unit 40 determines a phoneme sequence having a highest likelihood out of phoneme sequences registered in the system dictionary 60 as a phoneme sequence (s) corresponding to the ambient sound using the extracted sound feature amount. The sound recognition unit 40 stores the determined phoneme sequence (s) as a tag of a position from which the ambient sound is extracted in the ambient sound database 70. The tagging process is a process of correlating a section of the sound signal corresponding to the ambient sound with the phoneme sequence (s) which is a result of the recognition process on the sound signal of the ambient sound. The sound recognition unit 40 may perform a sound source direction estimating process, a noise reducing process, and the like, and then may perform the recognition process on the sound signal of the ambient sound.

FIG. 2 is a diagram illustrating a relationship between the sound signal of the ambient sound and the tag in this embodiment. In FIG. 2, the horizontal axis represents the time and the vertical axis represents a signal level of a sound signal. In the example illustrated in FIG. 2, an ambient sound in a section of times t₁ to t₂ is recognized as “Ka:N(s)” by the sound recognition unit 40, and an ambient sound in a section of times t₃ to t₄ is recognized as “Ko:N(s)” by the sound recognition unit 40. The sound recognition unit 40 performs labeling indicating a phoneme sequence (s) on the phoneme sequence (s), and stores the label in the ambient sound database 70 in correlation with the ambient sound data and the phoneme sequence (s).

With reference to FIG. 1 again, the ambient sound retrieving device 1 will be subsequently described.

The user dictionary 50 stores a dictionary used for the sound recognition unit 40 to recognize an onomatopoeic word emitted from a person. The user dictionary 50 stores an acoustic model indicating a relationship between a sound feature amount and a phoneme and a language model indicating a relationship between a phoneme and a language such as a word. The user dictionary 50 may store information of a plurality of users when the number of users is two or more, or the user dictionary 50 may be provided for each user.

The system dictionary 60 stores a dictionary used to recognize a sound signal of an ambient sound. In the system dictionary 60, data used for the sound recognition unit 40 to recognize a sound signal of an ambient sound is stored as a part of the dictionary. Here, since most of onomatopoeic words in Japanese are formed by combination of consonants and vowels, phoneme sequences in the form of “including consonant+vowel or long vowel” are stored in the system dictionary 60. FIG. 3 is a diagram illustrating information stored in the system dictionary 60 in this embodiment. As illustrated in FIG. 3, the system dictionary 60 stores phoneme sequences 201 and likelihoods 202 thereof in correlation with each other. The system dictionary 60 is a dictionary prepared through learning, for example, using hidden Markov model (HMM). The method of generating information stored in the system dictionary 60 will be described later.

Sound signals (ambient sound data) of ambient sounds to be retrieved are stored in the ambient sound database 70. Information indicating a position from which an ambient sound signal is extracted, information indicating a phoneme sequence of a recognized ambient sound, and a label attached to the ambient sound are stored in the ambient sound database 70 in correlation with each other. FIG. 4 is a diagram illustrating information stored in the ambient sound database 70 in this embodiment. As illustrated in FIG. 4, a label “cymbals”, a phoneme sequence (s) “Cha:N(s)”, ambient sound data “ambient sound data₁”, and position information “position₁” are stored in the ambient sound database 70 in correlation with each other. Here, the label “cymbals” is an ambient sound generated by a cymbals as a musical instrument, and the ambient sound of a label “candywols” is an ambient sound emitted when cooking metallic balls are beaten with metallic chopsticks. When an ambient sound is a sound signal extracted from a video signal, a video signal of a position from which the ambient sound is extracted may be stored in the ambient sound database 70 in correlation with the ambient sound data.

The correlation unit 80 correlates a phoneme sequence (s) recognized using the system dictionary 60 with a phoneme sequence (u) recognized using the user dictionary 50 and stores the correlation in the correlation information storage unit 90. The process performed by the correlation unit 80 will be described later.

In the correlation information storage unit 90, n (where n is an integer of 1 or greater) phoneme sequences (u) recognized using the user dictionary 50, n phoneme sequences (s) recognized using the system dictionary 60, and selection frequencies thereof are stored in a matrix shape as illustrated in FIG. 5. FIG. 5 is a diagram illustrating information stored in the correlation information storage unit 90 in this embodiment. In FIG. 5, items 251 in the row direction are phoneme sequences recognized using the system dictionary 60 and items 252 in the column direction are phoneme sequences recognized using the user dictionary 50.

As illustrated in FIG. 5, n (where n is an integer of 1 or greater) phoneme sequences (u) recognized using the user dictionary 50 and n phoneme sequences (s) recognized using the system dictionary 60 are stored in a matrix shape in the correlation information storage unit 90. As illustrated in FIG. 5, for example, a selection frequency₁₁ in which a phoneme sequence (s) “Ka:N(s)” is selected is stored in the correlation information storage unit 90 in correlation with a phoneme sequence (u) “Ka:N(u)”. The total number Tₘ (where m is an integer in a range of 1 to n) of selection frequencies of a phoneme sequence selected using the system dictionary is stored for each phoneme sequence recognized using the user dictionary 50. For example, T₁ is equal to selection frequency₁₁+selection frequency₂₁+ . . . +selection frequency₂ₙ. The correlation information storage unit 90 may not store the total number Tₘ. In this case, the ranking unit 120 may calculate the total number in a ranking process to be described later.

For example, the speech recognition result of a speech “Kan” emitted as an onomatopoeic word from a user for an ambient sound which the user is made to hear at the time of storage in the correlation information storage unit 90 is the phoneme sequence (u) “Ka:N(u)”. When the ambient sound data correlated with the phoneme sequence (s) “Ka:N(s)” is output, the number of times in which the user sets the ambient sound data correlated with the output phoneme sequence (s) “Ka:N(s)” as an answer to the phoneme sequence (u) “Ka:N(u)” is selection frequency₁₁. Similarly, when the ambient sound data correlated with the phoneme sequence (s) “Ki:N(s)” is output, the number of times in which the user sets the ambient sound data correlated with the output phoneme sequence (s) “Ki:N(s)” as an answer to the phoneme sequence (u) “Ka:N(u)” is selection frequency₂₁. The selection frequency is the number of times counted through learning at the time of preparing the correlation information storage unit 90 in this manner.

The conversion unit 100 converts the phoneme sequence (u) output from the sound recognition unit 40 into the phoneme sequence (s) stored in the system dictionary 60 using the information stored in the correlation information storage unit 90, and outputs the converted phoneme sequence (s) to the sound source retrieving unit 110. In this embodiment, the phoneme sequence (u) is also referred to as a user onomatopoeic word, and the phoneme sequence (s) is also referred to as a system onomatopoeic word. In this embodiment, the conversion process performed by the conversion unit 100 is also referred to as a translation process.

The sound source retrieving unit 110 retrieves ambient sound data including the phoneme sequence (s) output from the conversion unit 100 from the ambient sound database 70. The sound source retrieving unit 110 outputs the retrieved candidate of the ambient sound data to the ranking unit 120. When the number of candidates of the ambient sound is two or more, the sound source retrieving unit 110 outputs a plurality of candidates of the ambient sound to the ranking unit 120.

The ranking unit 120 calculates a recognition score for each candidate of the ambient sound. Here, the recognition score is an estimated value indicating which is “closest to a sound source desired by a user”. For example, the ranking unit 120 calculates a conversion frequency as the recognition score. The process performed by the ranking unit 120 will be described later. The ranking unit 120 outputs information indicating the ambient sound data subjected to the ranking process as a candidate of the ambient sound to the output unit 130. The ranking unit 120 may output only a predetermined number of candidates of the ambient sound sequentially from the highest rank out of the plurality of candidates of the ambient sound to the output unit 130.

The output unit 130 outputs information indicating the ambient sound ranked by the ranking unit 120. The output unit 130 is, for example, an image display device and a sound reproducing device. FIG. 6 is a diagram illustrating an example of ambient sounds ranked by the ranking unit 120 and supplied to the output unit 130 in this embodiment. As illustrated in FIG. 6, the information indicating the candidates of the ambient sound are supplied to the output unit 130 in the rank-descending order. As illustrated in FIG. 6, a rank 301, a label name 302, and a conversion frequency 303 are displayed in the output unit 130 in correlation with each other for each information piece indicating a candidate of the ambient sound. The ranking-descending order is an order in which the value of the conversion frequency 303 calculated by the ranking unit 120 descends from the highest value. The information presented to the output unit 130 may be only the label name 302. The output unit 130 may present the label names 302 from up to down depending on the ranks.

For example, in FIG. 6, the rank of 1, the label name of “cymbals”, and the conversion frequency of 0.405 in the first row are correlated and presented as a candidate of the ambient sound to the output unit 130. In FIG. 6, the label name “trashbox” indicates an ambient sound emitted, for example, when a metallic wastebasket is beaten with a metallic rod. The label name of “cup1” indicates an ambient sound emitted, for example, when a metallic cup is beaten with a metallic rod, and the label name of “cup2” indicates an ambient sound emitted, for example, when a resin cup is beaten with a metallic rod.

In FIG. 1, since the system dictionary 60 and the ambient sound database 70 are prepared in advance off-line, the ambient sound retrieving device 1 may not include the video input unit 20 and the sound signal extraction unit 30. Since the correlation information storage unit 90 may be prepared in advance, the ambient sound retrieving device 1 may not include the correlation unit 80.

An example of generation of a system onomatopoeic word model used for a system to recognize an onomatopoeic word, which is performed by the correlation unit 80, will be described below.

First, the correlation unit 80 performs HMM learning on sounds emitted from a user using labels given through speech recognition using an acoustic model for sound signals or labels given by a user, and prepares an acoustic model for system onomatopoeic words. Then, the correlation unit 80 recognizes learning data using the prepared acoustic model and updates the above-mentioned labels using the recognition result.

The correlation unit 80 repeats learning and recognizing of the acoustic model until the acoustic model converges, and determines that the acoustic model converges when the labels used for learning are matched with the recognition result by a predetermined value or more. The predetermined value is, for example, 95%. The correlation unit 80 stores the selection frequency of the system onomatopoeic word (s) for the user onomatopoeic word (u) selected in the course of learning in the correlation information storage unit 90 as illustrated in FIG. 5.

The process performed by the ranking unit 120 will be described below.

It is assumed that a user onomatopoeic word emitted from a user is pᵢ and a system onomatopoeic word into which pᵢ is translated is qⱼ. At this time, the ratio Rᵢⱼ at which a user onomatopoeic word pᵢ is transmitted into another system onomatopoeic word qⱼ is expressed by Expression (1).

$${R}_{ij} = \frac{count ( {q}_{j} )}{count ( {p}_{i} )} \qquad ( 1 )$$

Rᵢⱼ is referred to as a conversion frequency and the ranking unit 120 sequentially ranks the candidates of the ambient sound from the highest value. The conversion frequency Rᵢⱼ indicates a statistical ratio at which a user onomatopoeic word is translated into a system onomatopoeic word in the dictionary.

In Expression (1), count(pᵢ) indicates the total number Tₙ (see FIG. 5) for each phoneme sequence recognized using the user dictionary stored in the correlation information storage unit 90. In Expression (1), count(qᵢ) represents the selection frequency of the system onomatopoeic word qᵢ (see FIG. 5).

For example, when a user onomatopoeic word is Ka:N(u), the total number T1 of Ka:N(u) is assumed to be 100. It is also assumed that the selection frequency of the system onomatopoeic word Ka:N(s) corresponding to the user onomatopoeic word Ka:N(u) is 60, the selection frequency of the system onomatopoeic word Ka:N(s) corresponding to the user onomatopoeic word Ki:N(u) is 40, and the selection frequency of the system onomatopoeic word corresponding to another user onomatopoeic word Ki:N(u) is 0. In this case, the ratio Rᵢⱼ at which the user onomatopoeic word Ka:N(u) is converted into the system onomatopoeic word Ka:N(s) is 0.6 (=60/100). The ratio Rᵢⱼ at which the user onomatopoeic word Ka:N(u) is converted into the system onomatopoeic word Ki:N(s) is 0.4 (=40/100).

The ranking unit 120 may store the calculated conversion frequency Rᵢⱼ in the correlation information storage unit 90, for example, in correlation with the selection frequency.

An ambient sound retrieving process which is performed by the ambient sound retrieving device 1 will be described below. FIG. 7 is a flowchart illustrating the ambient sound retrieving process which is performed by the ambient sound retrieving device 1 according to this embodiment. The user dictionary 50, the system dictionary 60, the ambient sound database 70, and the correlation information storage unit 90 are prepared before performing retrieval of an ambient sound.

(Step S101) First, a user emits an onomatopoeic word imitating an ambient sound to be retrieved. Then, the sound input unit 10 collects the sound emitted from the user and outputs the collected sound to the sound recognition unit 40. Then, the sound recognition unit 40 performs the speech recognizing process on the sound signal output from the sound input unit 10 using the user dictionary 50 and outputs the recognized user onomatopoeic word (u) to the conversion unit 100.

(Step S102) The conversion unit 100 converts (translates) the user onomatopoeic word (u) recognized by the sound recognition unit 40 into a system onomatopoeic word (s) using the information stored in the correlation information storage unit 90. Then, the conversion unit 100 outputs the converted system onomatopoeic word (s) to the sound source retrieving unit 110.

(Step S103) The sound source retrieving unit 110 retrieves a candidate of an ambient sound corresponding to the system onomatopoeic word (s) output from the conversion unit 100 from the ambient sound database 70.

(Step S104) The ranking unit 120 ranks the plurality of candidates of the ambient sound retrieved in step S103 by calculating the conversion frequency Rᵢⱼ for each candidate. The ranking unit 120 outputs information indicating the ranked ambient sound data as the candidates of the ambient sound to the output unit 130.

(Step S105) The output unit 130 ranks and presents the candidates of the ambient sound output from the ranking unit 120, for example, as illustrated in FIG. 6.

(Step S106) The output unit 130 detects a position of a label selected by the user and reads the ambient sound data corresponding to the detected label form the ambient sound database 70. Then, the output unit 130 outputs the read ambient sound data.

A specific example of the process will be described below.

A user determines an ambient sound to be retrieved. Here, the user determines a sound generated when a cymbals is beaten as an ambient sound to be retrieved. Then, the user emits the sound generated when the cymbals is beaten as an onomatopoeic word “Jan” which the user has in mind.

Then, the sound recognition unit 40 performs a sound recognizing process on the sound signal “Jan” output from the sound input unit 10 using the user dictionary 50. It is assumed that the user onomatopoeic word (u) recognized by the sound recognition unit 40 is “Ja:N(u)” (step S101).

Then, the conversion unit 100 converts the user onomatopoeic word (u) “Ja:N(u)” recognized by the sound recognition unit 40 into a system onomatopoeic word (s) “Cha:N(s)” using the information stored in the correlation information storage unit 90 (step S102).

Then, the sound source retrieving unit 110 retrieves candidates “cymbals”, “candybwl”, . . . of the ambient sound corresponding to the converted system onomatopoeic word (s) “Cha:N(s)” from the ambient sound database 70 (step S103).

Then, the ranking unit 120 ranks the retrieved candidates “cymbals”, “candybwl”, . . . of the ambient sound by calculating the conversion frequency Rᵢⱼ for each candidate (step S104).

Then, the output unit 130 ranks and presents the plurality of candidates of the ambient sound to the display unit, for example, as illustrated in FIG. 6 (step S105).

Then, for example, when the output unit 130 includes a touch panel, the user touches the candidates of the ambient sound displayed on the output unit 130. When the output unit 130 detects that the user touches the position at which “cymbals” with rank 1 is displayed, the output unit 130 reads the ambient sound signal correlated with “cymbals” from ambient sound database 70 and outputs the read ambient sound signal (step S106). When the output ambient sound correlated with “cymbals” is not a desired ambient sound, the user further touches the candidates of the ambient sound with ranks 2 and 3.

As described above, the ambient sound retrieving device 1 according to this embodiment includes the sound input unit 10 configured to receive a sound signal, the sound recognition unit (sound recognition unit 40) configured to perform a speech recognition process on the sound signal input to the sound input unit and to generate an onomatopoeic word, the sound data storage unit (ambient sound database 70) configured to store an ambient sound and an onomatopoeic word corresponding to the ambient sound, the correlation information storage unit (correlation information storage unit 90) configured to store correlation information in which a first onomatopoeic word (user onomatopoeic word), a second onomatopoeic word (system onomatopoeic word), and a frequency (conversion frequency Rᵢⱼ) of selecting the second onomatopoeic word when the first onomatopoeic word is recognized by the sound recognition unit are correlated with each other, the conversion unit 100 configured to convert the first onomatopoeic word recognized by the sound recognition unit into the second onomatopoeic word corresponding to the first onomatopoeic word using the correlation information stored in the correlation information storage unit, and the retrieval and extraction unit (sound source retrieving unit 110, ranking unit 120, and output unit 130) configured to extract the ambient sound corresponding to the second onomatopoeic word converted by the conversion unit from the sound data storage unit and to rank and present a plurality of candidates of the extracted ambient sound based on the frequencies of selecting the plurality of candidates of the extracted ambient sound.

By employing this configuration, the ambient sound retrieving device 1 according to this embodiment converts the user onomatopoeic word obtained by recognizing a sound emitted from a user into a system onomatopoeic word using the information stored in the correlation information storage unit 90. Then, the ambient sound retrieving device 1 according to this embodiment retrieves candidates of the ambient sound corresponding to the converted system onomatopoeic word from the ambient sound database 70, ranks the retrieved candidates of the ambient sound, and presents the ranked candidates to the output unit 130. Accordingly, by employing the ambient sound retrieving device 1 according to this embodiment, a user can simply obtain a desired ambient sound even when a plurality of candidates of the desired ambient sound are presented.

FIG. 8 is a diagram illustrating an example of a confirmation result when candidates of an ambient sound are presented in the ambient sound retrieving device 1 according to this embodiment. In FIG. 8, the horizontal axis represents the frequency of selecting the candidates of an ambient sound until an ambient sound desired by a user is output, and the vertical axis represents the number of ambient sounds in which a desired ambient sound is acquired for each selection frequency.

In the confirmation result illustrated in FIG. 8, an actual environment speech-sound database in which ambient sounds 3146 files and 65 classes (with a sampling frequency of 16 kHz and quantization of 16 bits) is used.

Examples of the ambient sound include a sound of beating a piece of earthenware, a sound of a pipe, a sound of tearing a piece of paper, a sound of a bell, and a sound of a musical instrument. Phoneme sequences (system onomatopoeic words) generated by causing the sound recognition unit 40 to recognize the sound signals of such ambient sounds using the system dictionary 60 are stored in advance in the ambient sound database 70.

In the confirmation result illustrated in FIG. 8, the correlation information storage unit 90 learns some sample data using a cross-validation method, and the retrieval of the ambient sounds is confirmed using the other sample data.

The confirmation is performed in the following procedure. First, a user is made to randomly hear the ambient sounds of the other sample data. Thereafter, the user determines one ambient sound to be retrieved out of the heard ambient sounds and utters the determined ambient sound as an onomatopoeic word. The ambient sound retrieving device 1 ranks a plurality of candidates of the ambient sound corresponding to the onomatopoeic word uttered by the user and presents the ranked candidates to the output unit 130. The user sequentially selects information indicating the candidates of the ambient sound presented to the output unit 130 from rank 1. Then, when an ambient sound corresponding to the information indicating the selected candidates of the ambient sound is output, the user determines whether the output ambient sound is a desired ambient sound. For example, when the user determines that the candidates of the ambient sound with rank 1 is a desired ambient sound, the selection is first performed and thus the selection frequency is set to 1. When the user determines that the candidate of the ambient sound with rank 2 is a desired ambient sound, the selection is secondly performed and the selection frequency is set to 2. The confirmation is performed for each ambient sound of the other sample data. The number of ambient sounds for each selection frequency is collected as the confirmation result illustrated in FIG. 8.

As illustrated in FIG. 8, the number of ambient sounds in which a desired ambient sound is obtained with the selection frequency of 1 is about 150, the number of ambient sounds in which a desired ambient sound is obtained with the selection frequency of 2 is about 75, and the number of ambient sounds in which a desired ambient sound is obtained with the selection frequency of 3 is about 60.

Accordingly, in the confirmation result illustrated in FIG. 8, a sound source selection rate at which a desired ambient sound is obtained with the first selection is about 14% and the sound source selection rate at which a desired ambient sound is obtained with the second selection is about 45%. Here, the sound source selection rate is expressed by Expression (2).

Sound source selection rate(%)=Number per average selection frequency/total number of accesses×100 (2)

In Expression (2), the total number of accesses in the denominator is the total number of accesses until the user can obtain a desired ambient sound from the candidates of an ambient sound presented to the output unit 130 for a plurality of sample data pieces at the time of confirmation. The number per average selection frequency in the numerator is the number corresponding to the average selection frequency in the horizontal axis in FIG. 8.

As illustrated in FIG. 8, in the ambient sound retrieving device 1 according to this embodiment, the user can obtain a desired ambient sound with a small selection frequency.

In this embodiment, “Kan” and the like are described above as an example of an onomatopoeic word to be retrieved, but the invention is not limited to this example. Other examples of the onomatopoeic word may include a phoneme sequence “consonant+vowel+ . . . +consonant+vowel” such as “Kachi” and a phoneme sequence including a repeated word such as “Gacha Gacha”.

This embodiment describes an example where a user utters an onomatopoeic word corresponding to an ambient sound to be retrieved and this sound is recognized, but is not limited to this example. The sound recognition unit 40 may extract an onomatopoeic word by performing analysis of dependency relations and the like, analysis of word classes, and the like on the sound signal input from the sound input unit 10 using the user dictionary 50 and a known method. For example, when the sound uttered by a user is “please, retrieve Gashan”, the sound recognition unit 40 may recognize “Gashan” in the sound signal as an onomatopoeic word.

### Second Embodiment

The first embodiment describes an example where an onomatopoeic word uttered by a user is recognized and an ambient sound desired by the user is retrieved so as to retrieve a desired ambient sound, but this embodiment will describe an example where an ambient sound is retrieved using a text input by a user.

FIG. 9 is a block diagram illustrating a configuration of an ambient sound retrieving device 1A according to this embodiment. As illustrated in FIG. 9, the ambient sound retrieving device 1A includes a video input unit 20, a sound signal extraction unit 30, a sound recognition unit 40, a user dictionary (acoustic model) 50A, a system dictionary 60, an ambient sound database (sound data storage unit) 70, a correlation unit 80A, a correlation information storage unit 90, a conversion unit 100A, a sound source retrieving unit (retrieval and extraction unit) 110, a ranking unit (retrieval and extraction unit) 120, an output unit (retrieval and extraction unit) 130, a text input unit 150, and a text recognition unit 160. The functional units having the same functions as illustrated in FIG. 1 will be referenced by the same reference signs and a description thereof will not be repeated here.

The text input unit 150 acquires text information input from a keyboard or the like by a user and outputs the acquired text information to the text recognition unit 160. Here, the text information input from the keyboard or the like by the user is a text including an onomatopoeic word corresponding to a desired ambient sound. The text input to the text input unit 150 may be only an onomatopoeic word. In this case, the text input unit 150 may output the acquired text information to the conversion unit 100A.

The text recognition unit 160 performs analysis of dependency relations or the like on the text information output from the text input unit 150 using the user dictionary 50A and extracts an onomatopoeic word from the text information. The text recognition unit 160 outputs the extracted onomatopoeic word as a phoneme sequence (u) (user onomatopoeic word (u)) to the conversion unit 100A. When the text input to the text input unit 150 includes only an onomatopoeic word, the ambient sound retrieving device 1A may not include the text recognition unit 160.

The user dictionary 50A may store phoneme sequences corresponding to a plurality of onomatopoeic words as texts in addition to the acoustic model described in the first embodiment.

The correlation unit 80A correlates a phoneme sequence (s) recognized using the system dictionary 60 with a phoneme sequence (u) recognized using the user dictionary 50 in advance and stores the correlation in the correlation information storage unit 90.

The conversion unit 100A converts (translates) the user onomatopoeic word (u) output from the text recognition unit 160 into a system onomatopoeic word (s) through the same processes in the first embodiment. The conversion unit 100A outputs the converted system onomatopoeic word (s) to the sound source retrieving unit 110.

FIG. 10 is a flowchart illustrating a flow of an ambient sound retrieving process which is performed by the ambient sound retrieving device 1A according to this embodiment. The same processes as in FIG. 7 are referenced by the same reference signs.

(Step S201) A user inputs a text including an onomatopoeic word imitating an ambient sound to be retrieved. Then, the text input unit 150 acquires text information input from the keyboard or the like by the user and outputs the acquired text information to the text recognition unit 160. Then, the text recognition unit 160 extracts the onomatopoeic word from the text information output from the text input unit 150. The text recognition unit 160 outputs the extracted onomatopoeic word as a phoneme sequence (u) (user onomatopoeic word (u)) to the conversion unit 100A.

(Steps S102 to S106) The ambient sound retrieving device 1A performs the same processes as in steps S102 to S106 described in the first embodiment.

As described above, the ambient sound retrieving device 1A according to this embodiment includes the text input unit 150 configured to receive text information, the text recognition unit 160 configured to perform a text extracting process on the text information input to the text input unit and to generate an onomatopoeic word, the sound data storage unit (ambient sound database 70) configured to store an ambient sound and an onomatopoeic word corresponding to the ambient sound, the correlation information storage unit (correlation information storage unit 90) configured to store correlation information in which a first onomatopoeic word, a second onomatopoeic word, and a frequency of selecting the second onomatopoeic word when the first onomatopoeic word is extracted by the text recognition unit are correlated with each other, the conversion unit 100A configured to convert the first onomatopoeic word extracted by the text recognition unit into the second onomatopoeic word corresponding to the first onomatopoeic word using the correlation information stored in the correlation information storage unit, and the retrieval and extraction unit (sound source retrieving unit 110, ranking unit 120, and output unit 130) configured to extract the ambient sound corresponding to the second onomatopoeic word converted by the conversion unit from the sound data storage unit and to rank and present a plurality of candidates of the extracted ambient sound based on the frequencies of selecting the plurality of candidates of the extracted ambient sound.

According to this configuration, the ambient sound retrieving device 1A according to this embodiment retrieves candidates of a desired ambient sound by causing the user to input a text of an onomatopoeic word imitating an ambient sound to be retrieved, ranks the retrieved candidates of the ambient sound, and presents the ranked candidates of the ambient sound to the output unit 130.

In FIG. 9, when the ambient sound database 70 and the correlation information storage unit 90 are prepared in advance, the ambient sound retrieving device 1A may not include the video input unit 20, the sound signal extraction unit 30, the sound recognition unit 40, the system dictionary 60, and the correlation unit 80A.

The ambient sound retrieving device 1 described in the first embodiment and the ambient sound retrieving device 1A described in the second embodiment may be applied to a device that records and stores sounds such as an IC recorder, a mobile terminal, a tablet terminal, a game machine, a PC, a robot, a vehicle, and the like.

The video signals or the sound signals stored in the ambient sound database 70 described in the first and second embodiments may be stored in a device connected to the ambient sound retrieving device 1 via a network or may be stored in a device accessible thereto via a network. The number of video signals or sound signals to be retrieved may be one or more.

The estimation of a sound source direction may be performed by recording a program for performing the functions of the ambient sound retrieving device 1 or 1A according to the present invention on a computer-readable recording medium and reading and executing the program recorded on the recording medium into a computer system. The “computer system” mentioned herein may include an OS or hardware such as peripheral devices. The “computer system” may include a WWW system including homepage providing environments (or homepage display environments). Examples of the “computer-readable recording medium” include a flexible disk, a magneto-optical disk, a ROM, a portable medium such as a CD-ROM, and a storage device such as a hard disk built in a computer system. The “computer-readable recording medium” may include a medium holding a program for a predetermined time such as a nonvolatile memory (RAM) in a computer system serving as a server or a client in a case where the program is transmitted via a network such as the Internet or a communication line such as a telephone line.

The program may be transmitted from a computer system in which the program is stored in a storage device or the like thereof to another computer system via a transmission medium or by transmission waves in the transmission medium. Here, the “transmission medium” via which a program is transmitted means a medium having a function of transmitting information such as a network (communication network) such as the Internet or a communication circuit (communication line) such as a telephone line. The program may be designed to realize a part of the above-mentioned functions. The program may be a program, that is, a differential file (differential program) that can implement the above-mentioned functions being used in combination with a program recorded in advance in the computer system.

While preferred embodiments of the invention have been described and illustrated above, it should be understood that these are exemplary examples of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An ambient sound retrieving device comprising:
a sound input unit configured to receive a sound signal;
a sound recognition unit configured to perform a speech recognition process on the sound signal input to the sound input unit and to generate an onomatopoeic word;
a sound data storage unit configured to store an ambient sound and an onomatopoeic word corresponding to the ambient sound;
a correlation information storage unit configured to store correlation information in which a first onomatopoeic word, a second onomatopoeic word, and a frequency of selecting the second onomatopoeic word when the first onomatopoeic word is recognized by the sound recognition unit are correlated with each other;
a conversion unit configured to convert the first onomatopoeic word recognized by the sound recognition unit into the second onomatopoeic word corresponding to the first onomatopoeic word using the correlation information stored in the correlation information storage unit; and
a retrieval and extraction unit configured to extract the ambient sound corresponding to the second onomatopoeic word converted by the conversion unit from the sound data storage unit and to rank and present a plurality of candidates of the extracted ambient sound based on frequencies of selecting the plurality of candidates of the extracted ambient sound.

2. The ambient sound retrieving device according to claim 1, wherein the first onomatopoeic word is obtained by causing the sound recognition unit to recognize an onomatopoeic word corresponding to the ambient sound, and
wherein the second onomatopoeic word is obtained by causing the sound recognition unit to recognize the ambient sound.

3. The ambient sound retrieving device according to claim 1, wherein the first onomatopoeic word in the correlation information is determined so that a recognition rate at which the second onomatopoeic word is recognized as the onomatopoeic word corresponding to the candidate of the ambient sound is equal to or greater than a predetermined value.

4. An ambient sound retrieving device comprising:
a text input unit configured to receive text information;
a text recognition unit configured to perform a text extraction process on the text information input to the text input unit and to generate an onomatopoeic word;
a sound data storage unit configured to store an ambient sound and an onomatopoeic word corresponding to the ambient sound;
a correlation information storage unit configured to store correlation information in which a first onomatopoeic word, a second onomatopoeic word, and a frequency of selecting the second onomatopoeic word when the first onomatopoeic word is extracted by the text recognition unit are correlated with each other;
a conversion unit configured to convert the first onomatopoeic word extracted by the text recognition unit into the second onomatopoeic word corresponding to the first onomatopoeic word using the correlation information stored in the correlation information storage unit; and
a retrieval and extraction unit configured to extract the ambient sound corresponding to the second onomatopoeic word converted by the conversion unit from the sound data storage unit and to rank and present a plurality of candidates of the extracted ambient sound based on frequencies of selecting the plurality of candidates of the extracted ambient sound.

5. An ambient sound retrieving method comprising:
a sound data storing step of storing an ambient sound and an onomatopoeic word corresponding to the ambient sound as sound data;
a sound input step of inputting a sound signal;
a sound recognizing step of performing a speech recognition process on the sound signal input in the sound input step and generating an onomatopoeic word;
a correlation information storing step of storing correlation information in which a first onomatopoeic word, a second onomatopoeic word, and a frequency of selecting the second onomatopoeic word when the first onomatopoeic word is recognized in the sound recognizing step are correlated with each other;
a conversion step of converting the first onomatopoeic word recognized in the sound recognizing step into the second onomatopoeic word corresponding to the first onomatopoeic word using the correlation information;
an extraction step of extracting the ambient sound corresponding to the second onomatopoeic word converted in the conversion step from the sound data;
a ranking step of ranking a plurality of candidates of the extracted ambient sound based on frequencies of selecting the plurality of candidates of the extracted ambient sound; and
a presentation step of presenting the plurality of candidates of the ambient sound ranked in the ranking step.

6. An ambient sound retrieving method comprising:
a sound data storing step of storing an ambient sound and an onomatopoeic word corresponding to the ambient sound as sound data;
a text input step of inputting text information;
a text recognizing step of performing a text extraction process on the text information input in the text input step and generating an onomatopoeic word;
a correlation information storing step of storing correlation information in which a first onomatopoeic word, a second onomatopoeic word, and a frequency of selecting the second onomatopoeic word when the first onomatopoeic word is recognized in the text recognizing step are correlated with each other;
a conversion step of converting the first onomatopoeic word recognized in the text recognizing step into the second onomatopoeic word corresponding to the first onomatopoeic word using the correlation information;
an extraction step of extracting the ambient sound corresponding to the second onomatopoeic word converted in the conversion step from the sound data;
a ranking step of ranking a plurality of candidates of the extracted ambient sound based on frequencies of selecting the plurality of candidates of the ambient sound extracted in the extracted step; and
a presentation step of presenting the plurality of candidates of the ambient sound ranked in the ranking step.
